(19) United States
(12) Patent Application Publication
(10) Pub. No.: US 2020/0044323 A1
(43) Pub. Date: Feb. 6, 2020

(54) HEARING DEVICE HAVING AN ANTENNA FOR WIRELESS COMMUNICATION

(71) Applicant: Sonova AG, Staefa (CH)

(72) Inventors: Yves Oesch, Neuchatel (CH); Francois Callias, Fontaines (CH)

(21) Appl. No.: 16/471,139

(22) PCT Filed: Aug. 11, 2017
(86) PCT No.: PCT/EP2017/070410

§ 371 Date: Jun. 21, 2019

(30) Foreign Application Priority Data
Dec. 20, 2016 (EP) PCT/EP2016/081958

(51) Int. Cl. H01Q 1/27; H01Q 7/00; H04R 25/00

(52) U.S. Cl. CPC H01Q 1/273; H01Q 7/00; H04R 2225/51; H04R 25/60; H04R 25/554

(57) ABSTRACT

Hearing device (105), comprising: a housing (110); a processor (130) positioned within the housing (110); a microphone (235) electrically coupled to the processor (130); a transducer (108) electrically coupled to the processor (130); and a flexible circuit board carrying a loop antenna (140), wherein the flexible circuit board includes two bent joints configured to bend more than 5 degrees, wherein the flexible circuit board defines a first and second opening (315a-315c), wherein the first opening (315a) is configured to enable sound to travel through the first opening to one of the microphone (125), wherein the loop antenna (140) encompasses the first and second openings, and is electronically coupled to at least two capacitors (205) in series. The hearing device can operate over a range of frequencies (e.g., 2.4 to 2.485 GHz) to communicate with other devices or a network. Other devices can include smart phones, TVs, computers, smart speakers, automobiles, and devices capable of implementing a wireless communication system(e.g., ZigBee™ Bluetooth™, other IEEE 802.11 standard, or any proprietary protocol).

### TECHNICAL FIELD

The disclosed technology includes an antenna for wireless communication. More specifically, the disclosure includes an antenna for a hearing device configured to communicate wirelessly.

### BACKGROUND

Hearing devices are generally small and complex devices. Hearing devices can include a processor, microphone, speaker, memory, housing, and other electronical and mechanical components. Some example hearing devices are Behind-The-Ear (BTE), Receiver-Canal (RIC), In-The-Ear (ITE), Completely-In-Canal (CIC), and Invisible-In-The-Canal (IIC) devices. A user can prefer one of these hearing devices compared to another device based on hearing loss, aesthetic preferences, lifestyle needs, and budget.

As hearing device technology develops, users prefer hearing devices with more functionality. For example, users want hearing devices that are configured to communicate wirelessly. Wireless communication improves a user's experience and enables the user to access a network or other devices with their hearing device. Additionally, users want hearing devices that have a long battery life (e.g., several days or even weeks).

However, additional functionality may require changes to a hearing device. For example, hearing devices generally require a modified power supply (e.g., bigger or more efficient battery) to communicate wirelessly. Further, because hearing devices are small, it is difficult to find space for an antenna used in wireless communication on a hearing device. As the amount of available space for the hearing aid decreases, the size of the antenna decreases and that causes challenges in receiving a wireless communication of certain wavelengths. Accordingly, there are a number of challenges and inefficiencies created with additional functionality for hearing devices.

One solution for a hearing device with an antenna is disclosed in US Publication No. 20150201288. This publication discloses a loop antenna including a flex circuit on printed circuit board (PCB). Although this publication provides some technology for wireless connectivity for a hearing device, it has several shorting comings related to user friendliness, cost of manufacture, performance, and efficiency. Accordingly, a need exits to address the short comings of this publication and improve the antenna for hearing aid devices.

### BRIEF DESCRIPTION OF THE DRAWINGS

The disclosed technology and accompanying figures describe some implementations of the disclosed technology.

FIG. 1 illustrates a communications environment with a hearing device, electronic device, and network in accordance with some implementations of the disclosed technology.

FIGS. 2A-2D illustrates components of the hearing device shown in FIG. 1 in more detail from different views in accordance with some implementations of the disclosed technology.

FIG. 3 illustrates schematic diagram for the antenna in FIG. 1 in more detail in accordance with some implementations of the disclosed technology.

FIG. 4 illustrates a schematic circuit diagram for the antenna in FIG. 1 in accordance with some implementations of the disclosed technology.

FIG. 5 illustrates the hearing device shown in FIG. 1 with a shielding component in accordance with some implementations of the disclosed technology.

FIG. 6 is a block diagram with a schematic overview of the disclosed technology in accordance with some implementations of the disclosed technology.

The drawings are not drawn to scale and have various viewpoints and perspectives. The drawings are some implementations and examples. Additionally, some components and/or operations may be separated into different blocks or combined into a single block for the purposes of discussion of some of the embodiments of the disclosed technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

The disclosed technology includes an antenna for a hearing device. For example, the disclosed technology includes a loop antenna for a BTE or RIC hearing device where the loop antenna is disposed horizontally on top of a hearing device so that traces for the antenna circumvent a microphone or switch for the hearing device. Using the antenna, the hearing device can wirelessly communicate over a range of frequencies (e.g., 2.39 to 2.485 GHz including Bluetooth™ at 2.4 GHz) to other devices. Other devices can include smart phones, TVs, computers, smart speakers, automobiles, and devices capable of implementing a wireless communication standard (e.g., ZigBee™, Bluetooth™, or other IEEE 802.11 standard).

In some implementations, the disclosed technology includes a loop antenna with a planar structure. For example, a flexible PCB board with three substantially planar sections between two bending axes can carry a loop antenna composed of metal traces. The PCB board can have bends, forming angles between 0 and 30 degrees, to maximize the length of the loop antenna inside the curvature of the hearing device housing. The planar structure of the loop antenna can improve (e.g., optimize) the performance of the antenna through increased reception and transmission.

In addition to the planar structure, the antenna can include a number of capacitors to improve (e.g., optimize) the accuracy of the resonance frequency of the antenna. For example, the antenna can include 5 to 20 capacitors in series, where each capacitor has a capacitance value between one to ten picofarads (pF) (e.g., 1 to 5 pF). In some implementations, it may be preferred to have capacitors with values between 2 to 3 pF based on the wavelength or frequency for wireless communication. The antenna can also include a serial arrangement of metallic traces connected through the capacitors, where the metallic traces are built on a flexible PCB and where the serial capacitors are soldered on. The serial capacitors provide resonance of the antenna on a frequency used for transmitting or receiving data wirelessly to external devices. For example, the antenna can transmit or receive data from a hearing aid placed on the opposite ear of a user. In some implementations, the capacitors are surface mount device (SMD) capacitors mounted on top a PCB board.

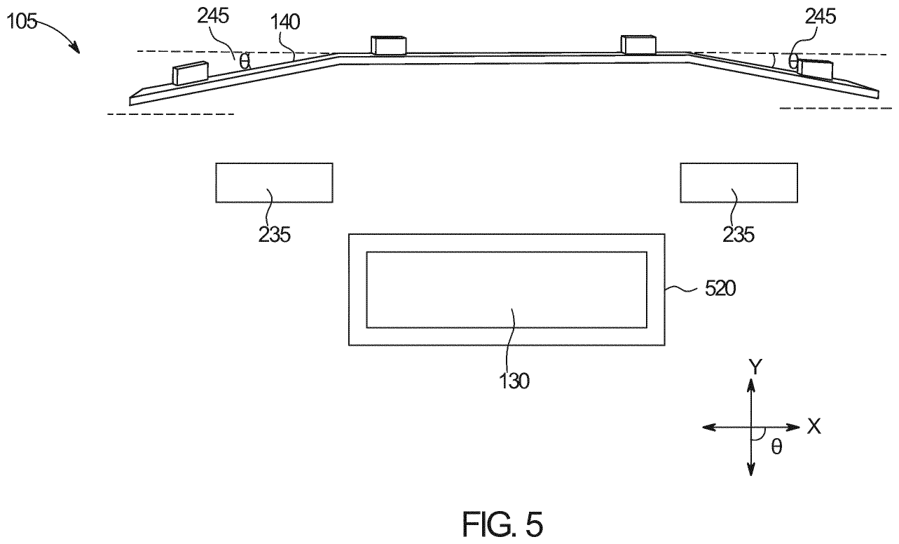

The disclosed technology can also include a shielding component that reduces (e.g., eliminates) electrical or magnetic interference between the antenna and the electronic equipment in a hearing device. For example, a shielding component can be positioned below the antenna and around the processor and other circuitry for a hearing aid. The shielding component can be spaced apart from the antenna by a shielding distance (e.g., 1 mm) such that the shielding component reduces (e.g., eliminates) interference with the operation of the antenna. The shielding component can be composed of sheet metal (e.g., copper), metal foam, or other composite. See FIG. 5 for more details regarding the shielding component.

The disclosed technology also includes a method of manufacturing a hearing device configured to transmit and receive wireless communication signals. A method of manufacturing a hearing device, comprising: placing a radio circuit within a housing for a hearing device; looping a flexible circuit to form an aperture and electronically coupling the flexible circuit and the radio circuit, wherein looping the circuit includes looping the circuit around a first and second opening formed by flexible circuit; and soldering 5 or more capacitors in series on the flexible circuit, wherein the capacitors are soldered at a distance relative to each other to transmit and receive wireless communication in a frequency range of 2.39 to 2.5 GHz.

In some implementations, the disclosed technology has at least one benefit. For example, one benefit is that a user can easily access a control (e.g., button, input, switch) for the hearing device without touching or disturbing the antenna or microphone; additionally, the hearing device is designed such that the antenna is positioned on the opposite side of the processor and away from other components to reduce manufacturing cost, complexity, and electronical interference from a processor. Also, the hearing device can include shielding between the antenna and circuitry to reduce electrical or magnetic interference within the hearing device.

Here are some definitions of terminology that apply to this disclosed technology.

| Term | Definition |
|---|---|
| A hearing system | is a system comprising a hearing device and one |
| | additional device (e.g., a hearing aid or mobile |
| | device). |
| Communication | is an electric device configured to wirelessly |
| device | communicate or to communicate with a wire. |
| A communication | is a system comprising one communication device |
| system | and another device. For example, a communication |
| | system is a mobile phone and a BTE hearing aid. |
| A hearing device | is a device that provides audio to a user; some |
| | example hearing devices include a hearing aid, |
| | headphones, earphones, assisted listening devices, |
| | or any combination thereof; and hearing devices |
| | also include both prescription devices and non- |
| | prescription devices configured to be worn on a |
| | human head. |
| A hearing device | is a component coupled to a hearing device; some |
| component | example hearing device components include cerumen |
| | protection, battery door, or sound tube. |
| A heading aid or | is a device that provides amplification or |
| hearing protection | attenuation (e.g., a hearing aid to compensate for |
| | hearing loss or attenuation functionalities) to a |
| | signal; some example hearing aids include a BTE, |
| | RIC, ITE, CIC, or IIC hearing aid. |

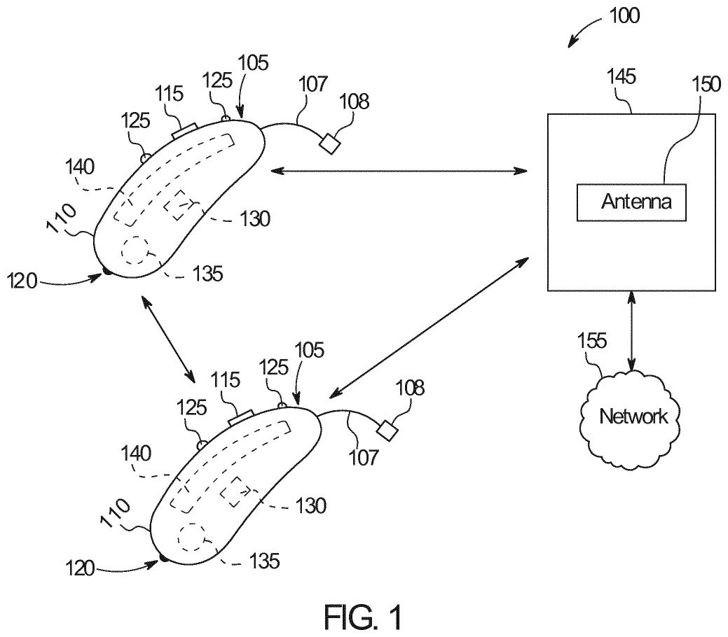

Beginning with a detailed description of the Figures, FIG. 1 illustrates an example of a hearing environment 100. The hearing environment 100 includes hearing devices 105, housing 110 for the hearing devices 105, tube 107, receiver 108, user input 115 (also referred to as a “user control”) for the hearing devices 105, battery door 120, sound entrances 125, processor 130, battery 135 (e.g., Zinc-Air, rechargeable, or lithium ion battery), and antenna 140. FIG. 1 shows processor 130, the battery 135, and the antenna 140 with dashed lines to indicate that these hearing device components are partially or completely inside the housing 110. FIG. 1 also includes an electronic device 145 with an antenna 150 for the electronic device 145 and network 155. The hearing devices 105 can communicate with the electronic device 145 or the hearing device 105 can communicate with the network 155 via the electronic device 145. Although two hearing devices 105 are shown in FIG. 1, the hearing environment 100 can include a single hearing device or a two hearing devices where only is configured to communicate wirelessly.

The electronic device 145 can be a mobile phone, smart phone, tablet computer, laptop computer, desktop computer, mobile media device, mobile gaming device, virtual or augmented reality headset, vehicle-based computer, wearable computing device, or portable electronic device. In some implementations, the electronic device 145 includes software or a mobile application that controls or communicates with the hearing device 105. In some implementations, the hearing device 105 can communicate with the electronic device 145 using Bluetooth™ or Zigbee™, or any proprietary protocol where signals are propagated between the antenna 140 and the antenna 150 (e.g., bidirectional communication). The hearing devices 105 can also communicate with each other. Each component of the hearing devices 105 is described below in more detail.

The hearing device 105 can receive input from the user input 115. For example, a user can push the user input 115 to signal pairing (e.g., Bluetooth pairing™) the hearing device 105 with another device such as the electronic device 145. In some implementations, a user can also use the battery door 120 as user input, e.g., to pair the hearing device 115 with another device or trigger communication between the hearing device and another device. For example, a user can open and close the battery door 120 a single time or multiple times to send an input signal to the hearing device 105.

The processor 130 controls and processes information for the hearing device 105. The processor 130 can include special-purpose hardware such as application specific integration circuits (ASICS), programmable logic devices (PLDs), field-programmable gate arrays (FPGAs), programmable circuitry (e.g., one or more microprocessors microcontrollers), Digital Signal Processor (DSP), appropriately programmed with software and/or firmware, or a combination of special purpose hardware and programmable circuitry. In some implementations, the processor 130 is physically and electronically coupled to memory such as volatile memory, nonvolatile memory and dynamic memory.

The network 155 can be a single network, multiple networks, or multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The network 155 can include communication networks such as a Global System for Mobile (GSM) mobile communications network, a code/time division multiple access (CDMA/TDMA) mobile communications network, a 3^{rd}, 4^{th} or 5^{th} generation (3G/4G/5G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network such as a Wireless Local Area Network (WLAN). In general, the network 155 enables the hearing devices 105 to send and receive information from the Internet via the electronic device 145. For example, the network 155 can be a Wi-Fi™ network or a networking implementing a IEEE 802.11 standard.

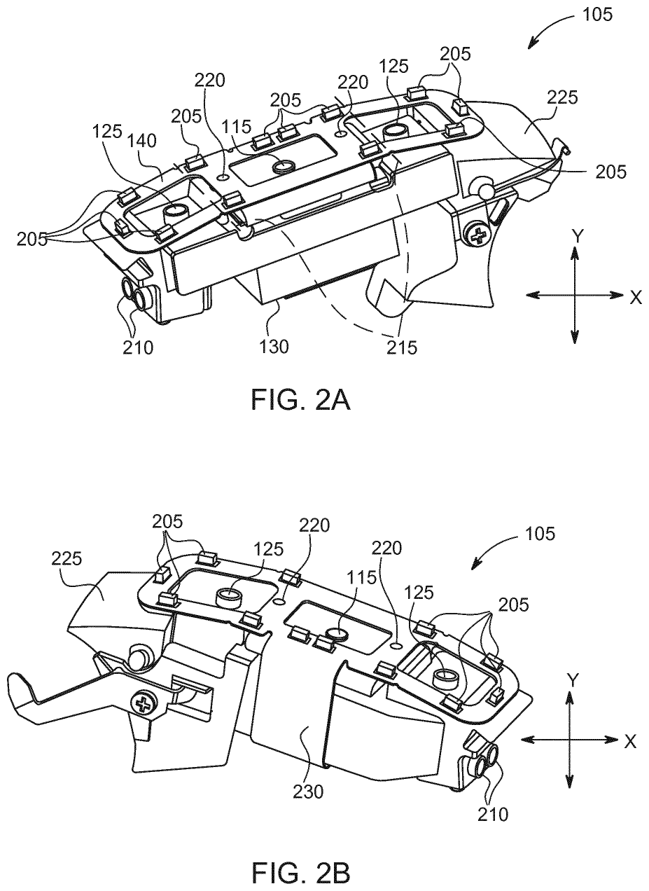

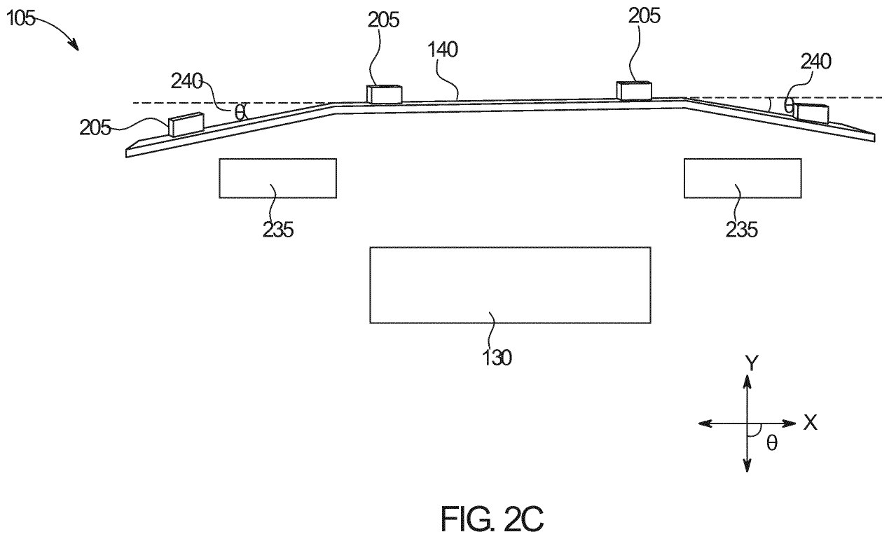

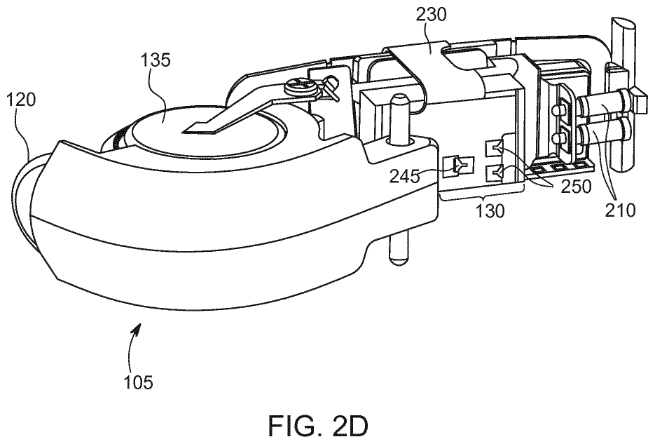

In order to wireless communicate with other devices, the hearing devices 105 use the antenna 140. The antenna 140 is described in more detail in FIGS. 2A-2D and FIGS. 3-6. The antenna 140 is configured to transmit and receive wireless communication signals in frequencies bands (e.g., in the 2.4 GHz frequency band). As shown in FIG. 1, the antenna can be completely inside the housing 110 (e.g., plastic). However, in some implementations, the antenna 140 can be partially or completely outside of the housing 110 depending on desired transmission and propagation properties. For hearing devices, it is generally preferred to protect the hearing aid components from moisture or environmental mental conditions by having all the hearing aid components inside the housing 110. Accordingly, the housing 110 can be composed of material that enables the transmission of wireless communication signals, but also reduces moisture (e.g., plastic).

Schematically removing the housing from FIG. 1, FIGS. 2A-2D illustrate different views and components of the hearing device 105 shown in FIG. 1 in more detail in accordance with some implementations of the disclosed technology. Each of the Figures is discussed in more detail below.

FIG. 2A includes the hearing device 105 with capacitors 205, connector 210 for connecting to the receiver 108 (e.g., an external loudspeaker), bending axes 215, positioning holes 220, and frame 225. FIG. 2A also includes a pass through hole for the user input 115, the processor 130, the antenna 140, and the sound entrances 125.

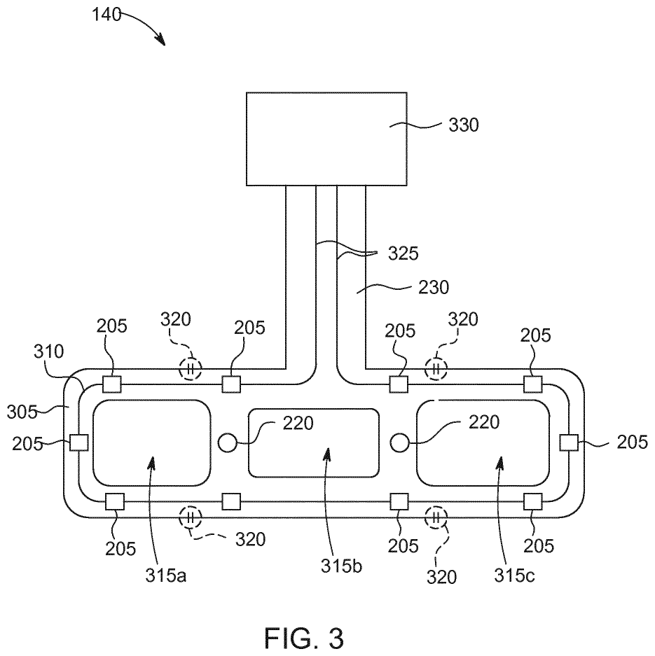

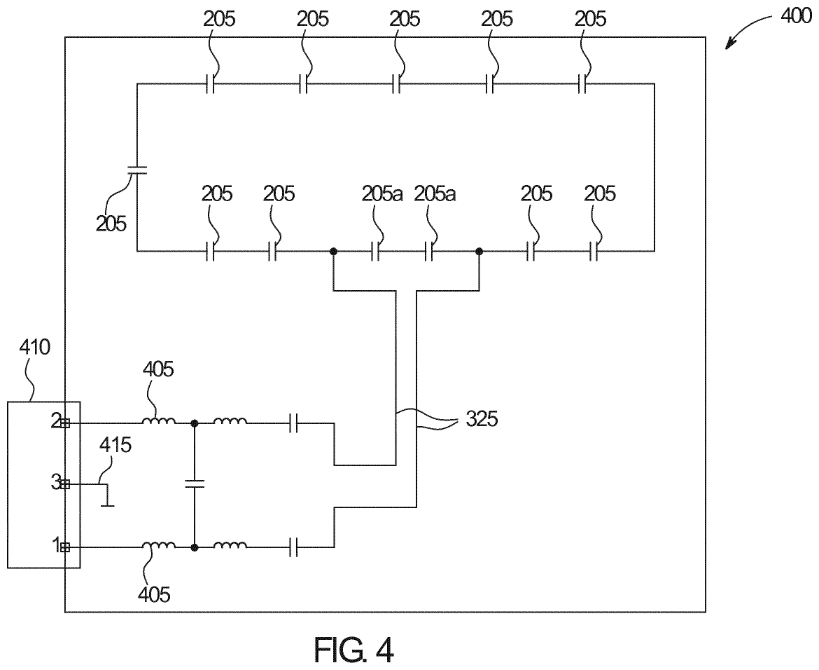

As shown in FIG. 2A, the antenna 140 is composed of multiple components including capacitors 205 and a flexible circuit board (e.g., PCB). The flexible circuit board is carrying, holding, or securing the antenna 140. The antenna 140 also includes metallic traces and is connected to a transmission line, which is explained in FIGS. 3 and 4. The antenna 140 can have multiple capacitors 205 (e.g., 12) positioned on top of the antenna 140. The hearing device 105 also includes the positioning holes 220 that can be used to maintain (e.g., hold or lock in place) the antenna 140 to the hearing device 105. The frame 225 provides structure and mechanical strength to the hearing device 105 and can be used to physically couple various hearing device components to the hearing device 105.

FIG. 2A also illustrates the bending axes 215. The bending axes 215 are flexible joints or choke points that enable the antenna 140 to bend at a particular angle (e.g., 0 to 30 degrees). The FIG. 2A also includes a coordinate system (x and y) to illustrate the particular bending angle and that the antenna 140 is higher on the y-axis than other components of the hearing device 105. For example, the antenna 140 is above or on top of the frame 225, the sound entrance 125, the processor 130, and at least part of the user input 115. The position of the antenna 140 enables the user to easily access the user input 115 without interfering with other components of the hearing device 105. Additionally, the antenna 140 is on the opposite side of the hearing device 105 relative to the processor to reduce electrical or magnetic interference between these components.

FIG. 2B includes the hearing device 105 without the housing 110. FIG. 2B also illustrates a different perspective of the hearing device 105. From this different perspective, FIG. 2B includes a transmission line 230. The transmission line 230 enables the transmission of signals from the antenna 140 to the processor 130. More details regarding the transmission structure are disclosed in FIG. 3.

FIG. 2C is another schematic perspective of the hearing device 105. FIG. 2C includes a folding angle 240. The folding angle 240 is defined as the angle between two planes, where the first plane is defined by the angle between two sections of the antenna 140 (e.g., the middle section and the two side sections). The antenna 140 is bends between the middle and side sections of the antenna 140, and the antenna 140 can bend by the folding angle (θ) 240. In some implementations, the folding angle 240 is between 0 to 40 degrees (e.g., 10 degrees). In some implementations, the folding angle 240 is different so that the front and the back of the antenna bend different amounts (e.g., 10 degrees and 15 degrees).

In Bluetooth™ communication when the hearing device is worn by a user on the user's ear, the folding angle 240 can be 10 degrees to improve (e.g., optimize) wireless communication such as the antenna 140 the antenna plane is substantially orthogonal to the user's head. Because the hearing device 105 includes the antenna 140 that bends at least at two points, the antenna 140 forms a plane that is substantially orthogonal to the user's head and ear while wearing the hearing device 105. By forming three substantially planar sections, the antenna 140 improves (e.g., optimizes) wireless communication, reception, and transmission of signals. In some implementations, substantially planar means each portion of the antenna is on a plane approximately (e.g., within a few degrees) perpendicular to a person's head wearing the hearing aid.

Rotating the perspective of FIG. 2C, FIG. 2D illustrates the bottom or lower part of the hearing device 105. FIG. 2D includes soldering grouping point 245 and transmission connection points 250. In some implementations, the soldering grouping point 245 and the transmission connection points 250 coupled to the processor 130 and the transmission line 240 increase (e.g., improve) the strength and integrity of the hearing device 105 because these components are hand mounted and soldered.

FIG. 3 illustrates schematic diagram for an antenna circuit for the antenna 140. FIG. 3 includes flexible circuit board 305, antenna lines 310, openings 315a-c, bending points 320, transmission lines 325, and attachment to the communication circuit 330. In general, FIG. 3 illustrates the passive components (e.g., capacitors 205 and antenna lines 310) that form part of the antenna. The antenna sections associated with the openings 315a-c are also referred to as three sections of the antenna 140. As shown in FIG. 3, the opening 315a including the flexible circuit and the metallic traces is on the left or first section, the opening 315b including the flexible circuit and the metallic traces is the middle or center section, and the opening 315c including the flexible circuit and the metallic traces is on the right or third section. The openings 315a and 315c can be identical in size and shape (e.g., squares with rounded edges), and the opening 315b can be different in size and shape compared to the openings 315a and 315c. For example, the openings 315a and 315c can be larger than the opening 315b because the microphones require a large sound channel compared to the user input. The opening 315b can also be a circle and the openings 315a and 315c can be squares. The shapes and sizes of openings 315a-c and the corresponding sections of the antenna 140 can be varied depending on microphone and sound channel specifications, user input specification, and size of the antenna. In some implementations, the first and third openings are round and the second opening is oblong, square, or rectangular. The shape of the holes can vary based on desired sound properties or activation (e.g., movement) of the user input. Although the size and shape vary, the openings 315a-c reduce (e.g., avoid) collision between the antenna and the other components of the hearing device 105.

The antenna 140 can receive signals and these signals travel to the communication circuit 330 through the transmission line 325 or the communication circuit 330 can transmit signals through the transmission line 325 to the antenna 140 to propagate the signals over the air. In some implementations, the transmission line 325 have a characteristic impedance between 50 and 300 ohm (e.g., 140 ohm), wherein the transmission line is of parallel line type. In some implementations, the transmission line 325 is a bifilar transmission line because it is to attached the bifilar transmission line 325 to a PCB and also because the transmission line 325 is symmetrical. Similarly, the communication chip 330 can have a symmetrical radio frequency (RF) input/output (I/O) physically coupled to the antenna 140, which is also symmetrical.

The antenna 140 includes the PCB board 305 with the antennas lines 310 sitting on top of the PCB board 305. The PCB board can define the openings 315a-c, where the openings enable the user input 115 (FIG. 1) and the sound entrances 125 (FIG. 1) to not interference with the antenna 140. For example, a user can push the user input 115 or sound can enter sound entrance 125 without a collision or interference with the antenna 140.

FIG. 4 illustrates an electronic schematic diagram 400 for the antenna 140. FIG. 4 includes the capacitors 205, inductors 405, antenna terminals 410, ground terminal 415 to ground the circuit. The antenna 140 can include 5 to 20 capacitors 205 (e.g., 12 as shown in FIG. 4) in series, where each capacitor 205 has a capacitance value between one to ten picofarads (pF). In some implementations, it may be preferred for the capacitors 205 to have values between 2 to 3 pF to optimize wireless communication. In some implementations, the inductors 405 have inductance values between 1 to 10 nH (e.g., 6.2 and 1.9 nH). The inductors can have a casing size of “0201”. The inductors 405 can be positioned near terminals to behave as a low pass filter and match impedance between the processor 130 and the transmission line 325.

In some implementations, the antenna 140 has a metallic traces between ⅙ and ½ of a wavelength for operating of the wavelength for operating the antenna (e.g., traces with a length of 0.021 meters and 0.0625 meters). For example the metallic traces can be ¼ of a wavelength.

FIG. 5 includes components of the hearing device 105 and a shielding component 520 (also referred to as a “shielding plate”). The shielding component 520 can be included in the hearing device 105 to reduce interference between the processor 130 or other electronic components of the hearing device 105. In some implementations, the shielding component 520 improves the performance of the hearing device 105 by reducing electrical and magnetic interference from the antenna 140 to other parts of electrical components of the hearing aid 105. As shown in FIG. 5, the shielding component 520 can also be positioned around the processor 130 as shown by the shielding component 520. In particular, the shielding plate 520 encompass part or all of the processor 130 to reduce (e.g., eliminate) electromagnetic interference between the antenna 140 and the processor 130. The shielding component 520 can completely surround the processor 130 or partially surround the processor 130.

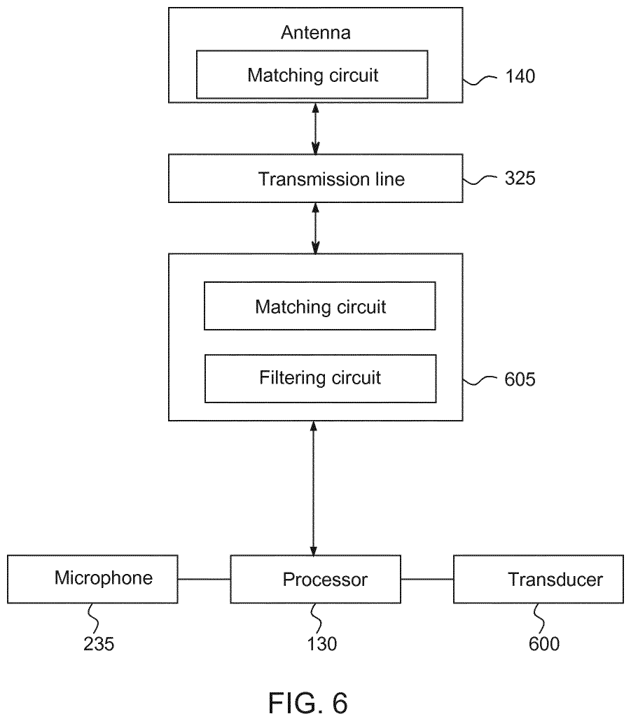

FIG. 6 is a block diagram with a schematic overview of the disclosed technology. FIG. 6 includes the antenna 140 (with a matching circuit), the transmission line 325, a communication unit 605 including a matching circuit and a filtering circuit, the processor 130, the microphone 235, and the transducer 600. The antenna 140 sends and receives signals through the transmission line 325. The transmission line 325 sends and receives signals from the communication unit 605. The communication circuit is connected to a filtering circuit (low-pass filter) for rejection of unwanted harmonics during transmission, and to a matching circuit that adapts the impedance of communication circuit to the impedance of the transmission line 325. The processor 130 can receive signals from the microphone 235 (e.g., audio signals) and transmit signals to the transducer 600. The transducer 600 can be a speaker (e.g., the speaker in a hearing aid) or another audio output device. The hearing device 105 (FIG. 1) can include all the components shown in FIG. 6.

In some implementations, the filter shown in FIG. 6 can be a bandpass filter that filters certain signals. For example, the filter can filter Long-Term Evolution (LTE) signals and/or 4G/5G signals. The filter can reduce interference between desired received signals (e.g., communication between a user's device and a user's hearing aid) and undesired signals at the antenna (e.g., LTE signals that are transmitted from or received by the user's cell phone). Some example bandpass filters can be 1920-1980 MHz or 1710-1755 MHz. The bandpass can depend on the types of interference (e.g., which cell phone carrier the user has or the location of the user and what cell phone or Wi-Fi connections are near the user).

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above detailed description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details. While, for convenience, implementations of the disclosed technology are described with reference to hearing device by customizing aesthetic and functional features/content, implementations of the disclosed technology are equally applicable to various other electronic devices and wireless communication equipment. For example, the disclosed technology can be used in a smart phone, smart speaker, automobile, radio, or airplane.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. The machine-readable medium includes non-transitory medium, where non-transitory excludes propagation signals. For example, a processor can be connected to a non-transitory computer-readable medium that stores instructions for executing instructions by the processor.

What is claimed:

1. A hearing device, comprising:
a housing;
a processor positioned within the housing;
a microphone electrically coupled to the processor;
a transducer electrically coupled to the processor; and
a flexible circuit board configured to carry a loop antenna,
wherein the flexible circuit board includes two bent joints that are bent more than 5 degrees,
wherein the flexible circuit board defines a first and second opening, wherein the first opening is configured to enable sound to travel through the first opening to the microphone,
wherein the loop antenna encompasses the first and second openings, and
wherein the antenna is electronically coupled to at least two capacitators in series.

2. The hearing device of claim 1, wherein the hearing device further comprising:
a user input,
wherein the housing defines a third opening, and
wherein the third opening is configured to enable activation for the user input.

3. The hearing device of claim 2, wherein the hearing device is a Behind-The-Ear (BTE) hearing aid, a Receiver-In-Canal (RIC) hearing aid, or a cochlear implant.

4. The hearing device of claim 1, wherein the loop antenna is configured to be positioned approximately in a horizontal plane with respect to a normal wearing position of the hearing device.

5. The hearing device of claim 1, wherein the loop antenna is configured to communicate using Bluetooth, Wi-Fi, ZigBee, an IEEE 802.11 communication standard, or a proprietary protocol.

6. The hearing device of claim 1, wherein the loop antenna is positioned above the microphone and located in an upper portion of the hearing device such that the processor is below the loop antenna when the hearing device is worn by a user.

7. The hearing device of claim 2, wherein the second opening encompasses at least a portion of the user input to avoid mechanical collision with the microphone and the user input.

8. The hearing device of claim 2, wherein the first opening has a round shape and the third opening has an oblong shape.

9. The hearing device of claim 1, wherein the loop antenna is symmetrical and physically coupled to a symmetrical transmission line, wherein the symmetrical transmission line is a bifilar transmission line.

10. The hearing device of claim 1, wherein the loop antenna has electrical conductors with lengths between ⅙ and ½ of a wavelength for operating the loop antenna.

11. The hearing device of claim 1, wherein the capacitors have a capacitance value between 1 and 5 pF.

12. The hearing device of claim 1, further comprising: a transmission line with a characteristic impedance between 50 and 300 ohm, wherein the transmission line is a parallel line type.

13. A hearing device, comprising:
a housing for a hearing device;
a user control coupled to a processor, the processor is configured to receive an input signal from the user input;
a microphone electronically coupled to the processor;
a transducer electronically coupled to the processor; and
a flexible circuit board configured to carry a loop antenna,
wherein the flexible circuit board defines a first and second opening, wherein the first opening is configured to enable sound to travel through the first opening to the microphone and the second opening is configured to enable activation of the user input, and
wherein the loop antenna that encompasses the first and second openings.

14. The hearing device of claim 13, wherein the flexible circuit board includes two bent joints that are bent more than 5 degrees, wherein one bent joint is bent a different amount than the other bent joint.

15. The hearing device of claim 13, wherein the loop antenna is configured to be positioned approximately in a horizontal plane with respect to a normal wearing position of the hearing device.

16. The hearing device of claim 13, wherein the loop antenna includes at least two capacitors in series.

17-27. (canceled)

28. A system, comprising:
a flexible circuit board;
a loop antenna including metallic traces carried on the flexible circuit board;
5 serial surface mount device (SMD) capacitors coupled to the metallic traces for the loop antenna,
wherein the SMD capacitors are soldered on the flexible circuit board, and
wherein the serial SMD capacitors provide at least partial resonance of the loop antenna on a frequency range used for wireless communication.

29. The system of claim 28, further comprising: a transmission line with a characteristic impedance between 50 and 300 ohm, wherein the transmission line is a parallel line type.

30. The system of claim 28, further comprising: a low-pass filter to enable signals with a frequency of 2.4 GHz band to pass from the antenna to the communication circuit.

31-37. (canceled)
